(19) United States
(12) Patent Application Publication
(10) Pub. No.: US 2013/0055136 A1
(43) Pub. Date: Feb. 28, 2013

(54) Methods, Systems, and Products for Controlling Quality of Service and Experience

(71) Applicants: Jeffrey A. Aaron, Atlanta, GA (US); Cagatay Buyukkoc, Holmdel, NJ (US); Robert C. Streijl, Chicago, IL (US)

(72) Inventors: Jeffrey A. Aaron, Atlanta, GA (US); Cagatay Buyukkoc, Holmdel, NJ (US); Robert C. Streijl, Chicago, IL (US)

(73) Assignee: AT&T INTELLECTUAL PROPERTY I, L.P., Atlanta, GA (US)

(21) Appl. No.: 13/214,268

(22) Filed: Aug. 22, 2011

(51) Int. Cl. G06F 3/048; G06F 15/173

(52) U.S. Cl. 715/772

(57) ABSTRACT

Methods, systems, and products allow users to optimize communications services. Network performance measurements are received that describe applications utilizing communications services from a communications network. The network performance measurements are displayed in a graphical user interface. When an icon in the graphical user interface is selected, the network performance measurements are displayed that are utilized by each application.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Exemplary embodiments generally relate to multiplex communications, telecommunications, computer data transfer, and to operator interfaces and, more particularly, to data admission, to path routing, to radio telephones, to computer networking, and to graphical user interfaces.

Customers want to control their communications services. Even though millions of customers utilize communications services, each customer generally receives the same service experience. Individualized, customer-controlled network configuration capabilities are deemed too expensive to implement.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIG. 1 is a simplified schematic illustrating a graphical user interface, according to exemplary embodiments;

FIG. 2 is a more detailed schematic illustrating an operating environment, according to exemplary embodiments;

FIG. 3 is another schematic illustrating the graphical user interface, according to exemplary embodiments;

FIGS. 4-7 are schematics illustrating changes to allotments, according to exemplary embodiments;

FIGS. 8-9 are schematics illustrating notifications, according to exemplary embodiments;

FIG. 10 is a schematic illustrating similarity of controls, according to exemplary embodiments;

FIGS. 11-14 are schematics illustrating different icons, according to exemplary embodiments;

FIGS. 15 and 16 are schematics illustrating a residential networking environment, according to exemplary embodiments;

FIGS. 17-18 are more detailed schematics illustrating the operating environment, according to exemplary embodiments; and

FIGS. 19-20 are flow charts illustrating a method for control of quality of service, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

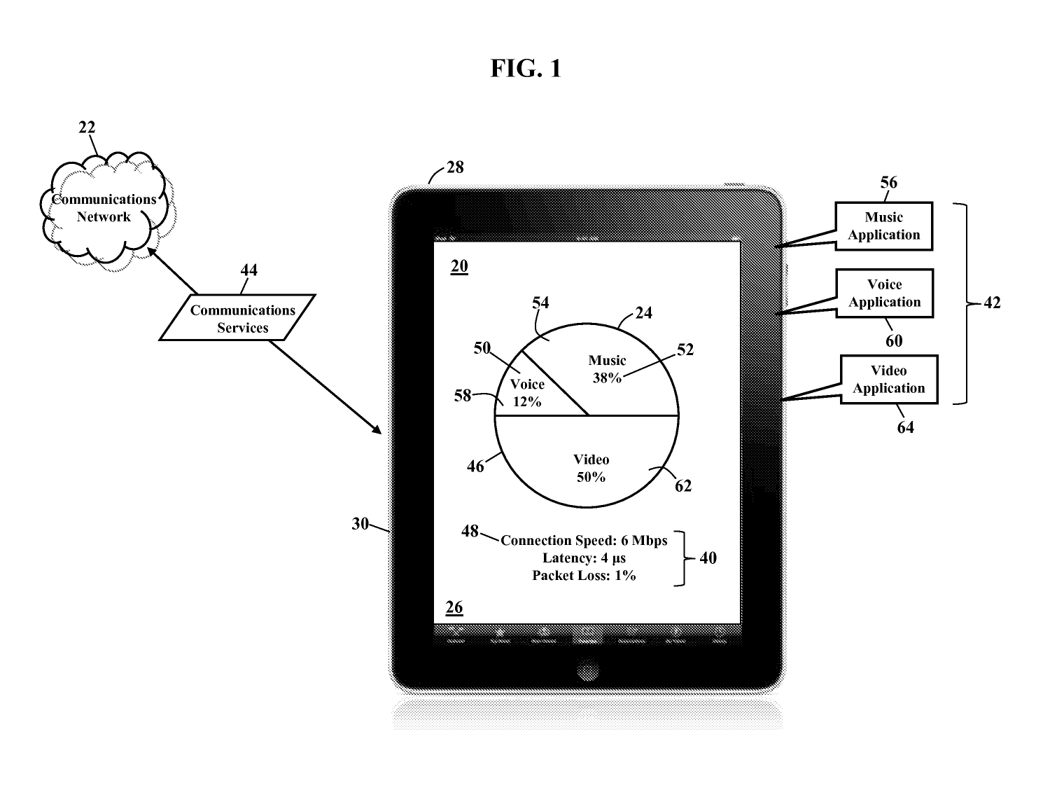

FIG. 1 is a simplified schematic illustrating a graphical user interface 20, according to exemplary embodiments. The graphical user interface 20 is a user-friendly interface for optimizing communications services. The graphical user interface 20 allows a user to control the quality and performance of communications services received from a communications network 22. As the user receives voice services, data services, video services, or any other communications and/or Internet services, the graphical user interface 20 allows the user to control the quality and performance of the communications services on an application-by-application basis. That is, the user may individually establish, and even change, the quality and performance received by individual applications. The user, for example, may control the quality and performance of a voice application to improve the quality of voice/data calls. The user, likewise, may also change the quality and performance received by a data application, and a video application, to improve data and video services. The user may make these changes to enhance the user's experience with movies, music, calls, and other bandwidth-intensive applications.

As FIG. 1 illustrates, the graphical user interface 20 may produce one or more icons 24. The graphical user interface 20 and the icons 24 are produced by a display 26 of a user device 28. The user device 28 is illustrated as a tablet computer 30 (such as an APPLE® IPAD®), but the user device 28 may be any processor-controlled device (as later paragraphs will explain). The icons 24, in particular, may display network performance measurements 40 for any software applications 42 that utilize communications services 44 from the communications network 22. Performance for groups or types of software applications, e.g., averaged and/or minimums and/or maximums, may also be selected and displayed (as later paragraphs will explain).

FIG. 1, for example, illustrates a pie chart 46. The pie chart 46 is only one example of the icon 24 that visually illustrates the quality and performance received by the software applications 42. At a glance the pie chart 46 displays, for example, a total amount 48 of bandwidth (perhaps in megabits/second) being entirely consumed by the software applications 42. Each slice 50 of the pie chart 46 graphically represents a proportional amount 52 of the total amount 48 of bandwidth being consumed (and/or available for consumption) by each application in the software applications 42. A music slice 54, for example, represents proportional bandwidth being consumed (and/or available for consumption) by a music application 56 (such as streaming music). A voice slice 58 represents proportional bandwidth being consumed (and/or available for consumption) by a voice application 60 (such as a telephone call or a Voice-over Internet Protocol call). A video slice 62 represents proportional bandwidth being consumed (and/or available for consumption) by a video application 64 (such as a streaming movie). With a quick glance, then, the user is able to quickly determine the total bandwidth being consumed (and/or available for consumption) by the user device 28 and how much bandwidth is individually consumed by each software application 42. Later paragraphs will explain controls for adjusting the proportional bandwidth being consumed (and/or available for consumption) by each software application 42. Moreover, the pie chart 46 is only one example of the icon 24, and any graphical element may be used to convey the total amount 48 of bandwidth and the proportional bandwidth (as later paragraphs will explain).

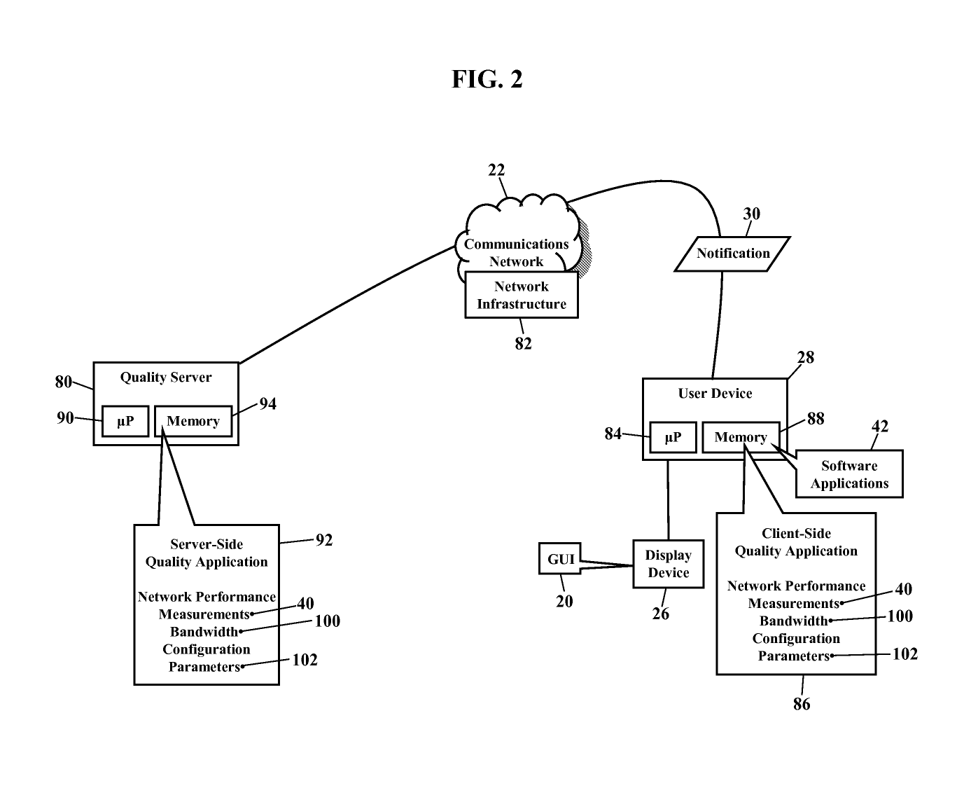

FIG. 2 is a more detailed schematic illustrating an operating environment, according to exemplary embodiments. Here the user device 28 communicates with a quality server 80. The quality server 80 determines what network performance measurements 40 (or any other quality related parameters) are accessible to, and changeable by, the client user device 28. Moreover, the quality server 80 interfaces with network infrastructure 82 for the communications network 22. The quality server 80 may also partially or fully control, or even partially or fully perform, any calculations that may be necessary to determine the quality and performance received by the software applications 42 executing on the user device 28. The quality server 80 may also determine additional network resources that may be required to implement changes in the network performance measurements 40.

The user device 28 and the quality server 80 cooperate. The user device 28 may have a processor 84 (e.g., “μP”), application specific integrated circuit (ASIC), or other component that executes a client-side quality application 86 stored in a memory 88. The client-side quality application 86 may cause the processor 84 to produce the graphical user interface (“GUI”) 20 on the display 26, yet the graphical user interface 20 may also have audio and/or video features. The quality server 80 may also have a processor 90 (e.g., “μP”), application specific integrated circuit (ASIC), or other component that executes a server-side quality application 92 stored in a memory 94. The client-side quality application 86 and the server-side quality application 92 cooperate to modify the network performance measurements 40 that are accessible to the client user device 28.

The network performance measurements 40 may describe any configuration parameters 102 and preferences of the communications network 22. For most residential and business customers, bandwidth 100 may be the broadest and simplest measurement of network performance. More sophisticated users, however, may configure other configuration parameters 102, such as packet loss, jitter, and latency on an application-by-application and/or service-by-service basis. That is, the user may subdivide network performance measurements 40 and allot or carve ranges of the configuration parameters 102 to specific applications and/or services.

The network performance measurements 40 may additionally or alternatively be expressed as threshold values. The user may define various threshold values of quality for any software application 42 (perhaps defined by a service level agreement). If quality can be met using a lower bandwidth, then perhaps more costly network resources are unnecessary. The network performance measurements 40 may thus be expressed as minimum or maximum threshold values, and the service provider manages the communications network 22 to satisfy the thresholds.

Exemplary embodiments are more advanced than a conventional “turbo button.” Some modems, routers, and computers have, in the past, had a turbo button for “bandwidth on demand,” where the user is in control and may temporarily request more bandwidth. This conventional feature is limited to request/control of bandwidth, which is only one quality of service component. This conventional feature, moreover, does not affect a specific service or application, but rather applies increased bandwidth to all services/applications, typically for a specified amount of time and for a predetermined amount of additional bandwidth and is not configurable by the user. This conventional “turbo button,” in other words, controls the bandwidth of an entire data “pipe” or connection to the user. Exemplary embodiments, in contradistinction, allow the user to specify sub-divisions of the “pipe,” according to different applications and services utilizing the communications network 22. Exemplary embodiments thus display the present quality of service and quality of experience being received by the user device 28. Exemplary embodiments also allow the user to change the quality of service and quality of experience on an application-by-application and/or service-by-service basis, such as the relative sizes of the sub-divisions of the data “pipe” serving the user device 28. Exemplary embodiments thus provide the graphical user interface 20 (and/or the icon 24, illustrated in FIG. 1) that meters and controls the sub-divisions of the bandwidth 100 and/or other additional aspects of quality of service and quality of experience.

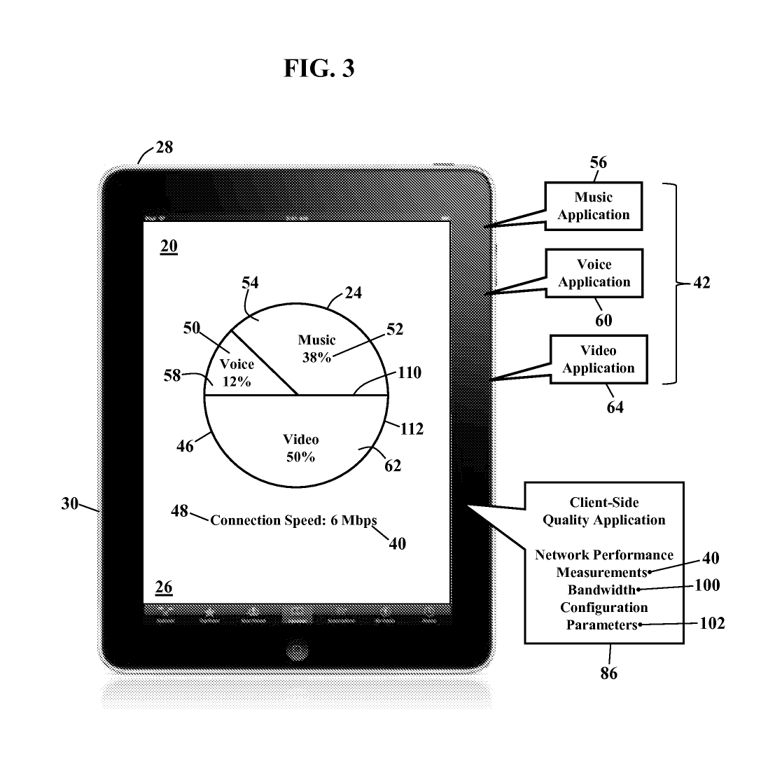

FIG. 3 is another schematic illustrating the graphical user interface 20, according to exemplary embodiments. FIG. 3 illustrates how the user may quickly and easily change their configuration parameters 102 within the communications network 22. FIG. 3, in particular, illustrates how the user may graphically change their configuration parameters 102 and allocate different network performance measurements 40 to different applications and services.

FIG. 3 again illustrates the pie chart 46. The client-side quality application 86 allows the user to change their configuration parameters 102 by simply changing the size of each slice 50 of the pie chart 46. Because bandwidth 100 is a simple measurement of network performance, FIG. 3 only illustrates the single pie chart 46 that allots the bandwidth 100 between different applications and services. The graphical user interface 20, however, may graphically produce multiple pie charts, with each individual pie chart 46 dedicated to a different configuration parameter 102 (such as packet loss, jitter, and latency). The user may then individually allot different configuration parameters 102 to different applications and services.

FIG. 3, for simplicity, illustrates the pie chart 46 for the bandwidth 100. A size of the pie chart 46 may visually represent the total amount 48 of bandwidth (e.g., 6 megabits/second) being cumulatively consumed, in total, by all the software applications 42. The diameter 110 or the circumference 112 of the pie chart 46 may visually represent the total amount 48 of bandwidth, with larger sizes (e.g., larger diameter 110 or circumference 112) indicating greater bandwidth 100 is being consumed by the software applications 42. Each slice 50 of the pie chart 46 represents the proportional amount 52 of the total amount 48 of bandwidth being consumed by each application in the software applications 42. If the video application 64 is consuming fifty percent (50%) of the total amount 48 of bandwidth, then the video slice 62 is preferably 50% of an area of the pie chart 46. The video slice 62, in other words, is graphically illustrated to equal the ratio of the proportional bandwidth 52 being consumed by the video application 64.

The remaining bandwidth must also be allocated. If the video application 64 is consuming fifty percent (50%) of the total amount 48 of bandwidth provided to the user device 28, the remaining 50% of the total amount 48 of bandwidth is available to other services and applications executing on the user device 28. The remaining 50% of the total amount 48 of bandwidth, for example, must be allocated between, for example, the music application 56 and the voice application 60. If the user wants to simultaneously watch a movie, listen to music, and receive a call, the remaining 50% of the total amount 48 of bandwidth is consumed by music and calls. The music slice 54 and the voice slice 58 thus represent the proportional bandwidth 52 being consumed by the music application 56 and the voice application 60. Again, then, with a quick glance the user is able to quickly determine the total bandwidth 48 being consumed by the user device 28 and how much bandwidth is individually consumed by each software application 42.

The icon 24 may have any geometrical shape. FIGS. 1-3 illustrate the icon 24 as the circular pie chart 46. Any type and style of icon 24, however, is applicable and/or adaptable to indicate quality and performance received from the communications network 22 (as later paragraphs explain). The pie chart 46, however, currently seems the simplest to understand, and the easiest to manipulate, for most users.

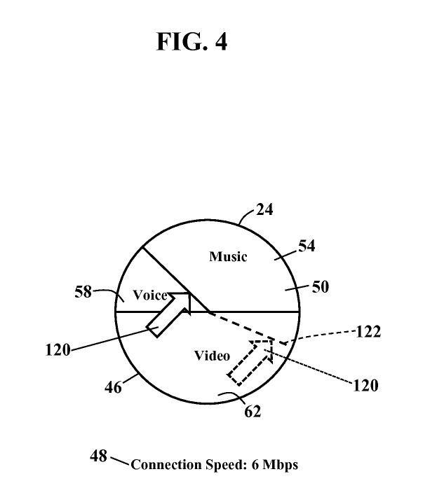

FIGS. 4-7 are schematics illustrating changes to allotments, according to exemplary embodiments. FIGS. 4-7, for simplicity, only illustrate the icons 24, and the icons 24 are enlarged for clarity. As the above paragraphs have hinted, exemplary embodiments permit the user to adjust the configuration parameters (illustrated as reference numeral 102 in FIGS. 2 & 3) assigned to, or consumed by, each software application (illustrated as reference numeral 42 in FIGS. 1-3). The sizes of the slices 50 may be graphically changed to adjust the values of the configuration parameters 102. FIG. 4, for simplicity, illustrates allotments for the bandwidth 100. The sizes of the slices 50 may be changed to adjust the bandwidth 100 individually consumed by each software application 42. The user may select any slice 50 and adjust the size of the slice 50 to modify its associated bandwidth. The user, for example, may place a cursor 120 on any slice 50 and drag an edge 122 of the slice 50 to increase, or decrease, its proportional bandwidth. Because the total area of the pie chart 46 represents the total amount 48 of bandwidth provided to the user device 28, changing the size of any slice 50 may force a corresponding increase, or reduction, in the sizes of other slices (as later paragraphs will explain).

Suppose, for example, that the user wishes to increase the bandwidth allocated to the music application (illustrated as reference numeral 56 in FIGS. 1 & 3). The user may place the cursor 120 on the music slice 54 and drag the edge 122 of the music slice 54 to increase the size of the music slice 54. The client-side quality application (illustrated as reference numeral 86 in FIGS. 2-3) then communicates with the server-side quality application (illustrated as reference numeral 92 in FIGS. 2-3) to change the values of the configuration parameters (illustrated as reference numeral 102 in FIGS. 1 & 3) to increase the bandwidth allocated to the music application 56. If the total amount 48 of bandwidth provided to the user device (illustrated as reference numeral 28 in FIGS. 1-4) is capped or limited to some maximum value, then increasing the bandwidth allocated to the music application 56 may force a corresponding reduction in the bandwidth provided to the video application and/or to the voice application (illustrated, respectively, as reference numerals 64 and 60 in FIGS. 2-3). The client-side quality application 86 and the server-side quality application 92 may then cooperate to determine the corresponding reduction in the bandwidth that must be implemented. The bandwidth allocated to the video application 64 and the voice application 60 may be proportionally and equally reduced, or either application 60, 64 may be subordinate and bear the full reduction in allocated bandwidth. Rules, algorithms, and/or thresholds may be employed, as later paragraphs will explain. The client-side quality application 86 and the server-side quality application 92 may be configured to determine which services or applications are reduced to maintain the total amount 48 of bandwidth provided to the user device 28.

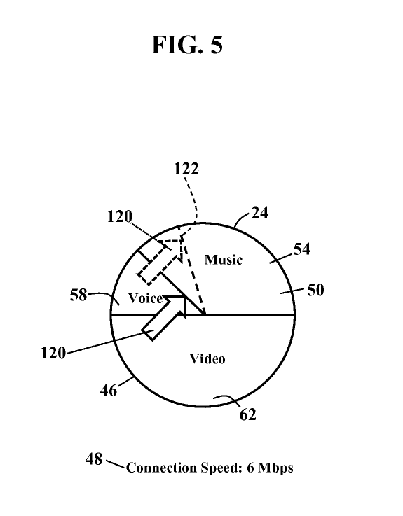

FIG. 5 illustrates reductions in bandwidth. The user may also similarly decrease the bandwidth allocated to any application or service. When the user wishes to decrease bandwidth, the user places the cursor 120 on the desired application and drags the edge 122 of the slice 50 to reduce its size. Suppose the user wishes to decrease the bandwidth allocated to the music application (illustrated as reference numeral 56 in FIGS. 1 & 3). Here the user drags the edge 122 of the video slice 62 to reduce its size. The client-side quality application 86 communicates with the server-side quality application 92 to change the values of the configuration parameters 102 to decrease the bandwidth allocated to the video application 64. Decreasing the bandwidth allocated to the music application 56 may thus free-up, or make available, additional bandwidth that may be shared or allocated by the voice application 60 and/or the video application 64. The client-side quality application 86 and the server-side quality application 92 may then cooperate to determine the corresponding increase in the bandwidth that may be implemented. Again, available bandwidth may be reserved for a priority application, or the available bandwidth may be shared per preferences.

Exemplary embodiments may also utilize gestures. FIGS. 4-5 illustrate the use of the cursor 120 to drag edges to increase, or decrease, proportional bandwidth. The user, however, may use gestures to increase or decrease sizes of slices. The display 26 of the user device 28 may respond to fingertip gestures that change the size and/or orientation of the slices 50. Swiping gestures, for example, may be used to move slices 50 and/or any portion of the icon 24. Keyboard commands may also be used to change shapes, locations, and/or sizes of the icon 24.

The icon 24 may have any other geometrical shape. The user, for example, may drag the edge 122 of the slice 50 to change its shape to suit the user's desires. The user may prefer rectangles, triangles, or even a different shape for each software application 42. Any type and style of icon 24 may be used to indicate quality and performance.

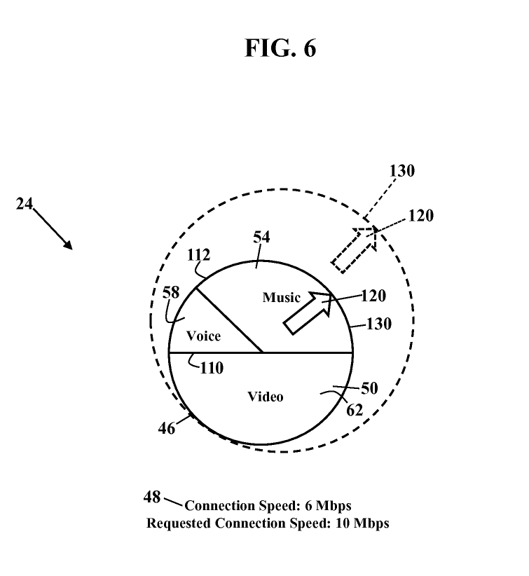

FIG. 6 illustrates changes in the total amount 48 of bandwidth consumed. Here the user may graphically increase, or decrease, the total amount 48 of bandwidth available to the user device from the communications network (illustrated, respectively, as reference numerals 28 and 22 in FIGS. 1-2). Because the size of the pie chart 46 may visually represent the total amount 48 of bandwidth available to the user device 28, the user may graphically change the size of the pie chart 46 to increase, or decrease, the total amount 48 of bandwidth. When the user wishes to increase bandwidth, the user enlarges the diameter 110 and/or the circumference 112 of the pie chart 46. Similarly, when the user wishes to decrease bandwidth, the user decreases the diameter 110 and/or the circumference 112 of the pie chart 46. The user, for example, places the cursor 120 on an outer, circumferential edge 130 of the pie chart 46 and drags the circumferential edge 130 to change its size. The client-side quality application 86 and the server-side quality application 92 then change the configuration parameters 102 in the communications network 22 to reflect the user's changes to the total amount 48 of bandwidth available to the user device 28.

Changes to the total amount 48 of bandwidth may affect allotments. When the user changes the total amount 48 of bandwidth available to the user device 28, those changes may affect the bandwidth allocated to any application or service. If the total amount 48 of bandwidth is increased, for example, increased bandwidth may be dedicated to a particular service or application. The increased bandwidth may alternatively be shared according to priorities established by the user and/or by the client-side quality application 86 and/or the server-side quality application 92. If the total amount 48 of bandwidth is decreased, bandwidth may be reduced to a particular service or application or proportionally reduced by all applications 42, again according to priorities, preferences, rules, algorithms, and/or thresholds.

Other geometrical shapes may be used. Even though the circular pie chart 46 is illustrated, the user may graphically change the pie chart 46 to any desired shape. The pie chart 46 may be changed to an oval shape, for example, by enlarging only one major axis (e.g., the diameter 110). Gestures and/or keyboard commands may be used to change shapes, locations, and/or sizes of the icon 24.

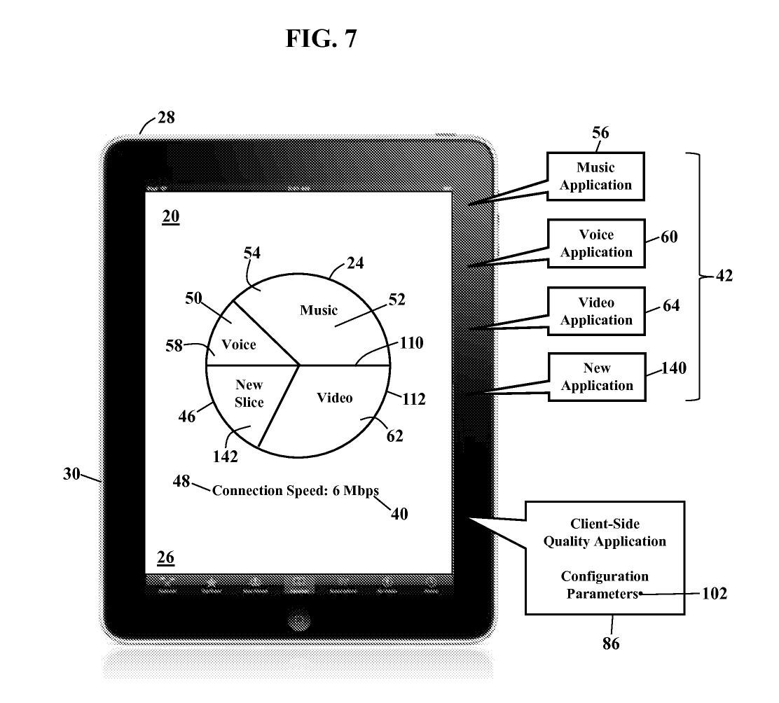

FIG. 7 illustrates additions and removal of slices. If the user wishes to add, or open, a new application 140, the client-side quality application 86 may graphically add a new slice 142 to the pie chart 46. The new slice 142 may be labeled to correspond to the newly-opened application 140. The client-side quality application and the server-side quality application (illustrated, respectively, as reference numerals 86 and 92 in FIGS. 2-3) then negotiate the configuration parameters 102 in the communications network 22 to provide whatever service is needed by the new application 140. The pie chart 46 may similarly reflect an end of a service or application. When the user closes any application 42, the client-side quality application 86 may graphically remove the corresponding slice 50 that corresponds to a closed application.

Exemplary embodiments may thus readily add and delete slices 50, potentially depending on the view. If specific applications (e.g., FACEBOOK® or TWITTER®) are illustrated in the graphical user interface 20, the graphical user interface 20 may list the bandwidth allocated for each application, and the specific network performance measurements 40 that reflect the quality of service for each application. The graphical user interface 20 may also present a view of overall services, such as voice, messaging, video, data, and others. The graphical user interface 20 may even present two views with multiple pie charts that are related. A change in an application view, such as by adding the new slice 140, may impact the allocation of services and be directly visible in a service view, and vice versa.

Exemplary embodiments may illustrate even more information. Exemplary embodiments, for example, may not only illustrate slices 50 for active software applications 42, but exemplary embodiments may visually illustrate any or all software applications 42 resident on the user device 28. That is, even if a software application 42 is not open or running, the icon 24 may still illustrate minimized, closed, or not running software applications 42. Exemplary embodiments may even illustrate quality and performance for groups of software applications. Each software application 24 may be mapped or associated with a “type” of application. For example, YOU TUBE® and FLASH® may both be mapped to a group of “video” applications, whereas SKYPE® and other voice-over Internet Protocol applications may be automatically mapped to a group of “voice” applications. Any software application having video chat capabilities may be mapped to group of “real-time video” applications. Exemplary embodiments may thus illustrate groups/types of applications, not per application views.

Exemplary embodiments may enhance the slices 50 to convey information. Coloring and shading, for example, may be used as status indicators. A slice 50 may have green fill or coloring to indicate a good or pass status. The edges 122 of any slice 50 may likewise have coloring to indicate status. Blinking or flashing icons 24 may indicate problems, concerns, or progress indicators. A flashing slice 50, for example, may indicate that negotiations are in progress or in transition. Red coloring or fill may indicate problems with allocations. Coloring and shading, in short, may be used as status indicators to further convey and simplify the icons 24.

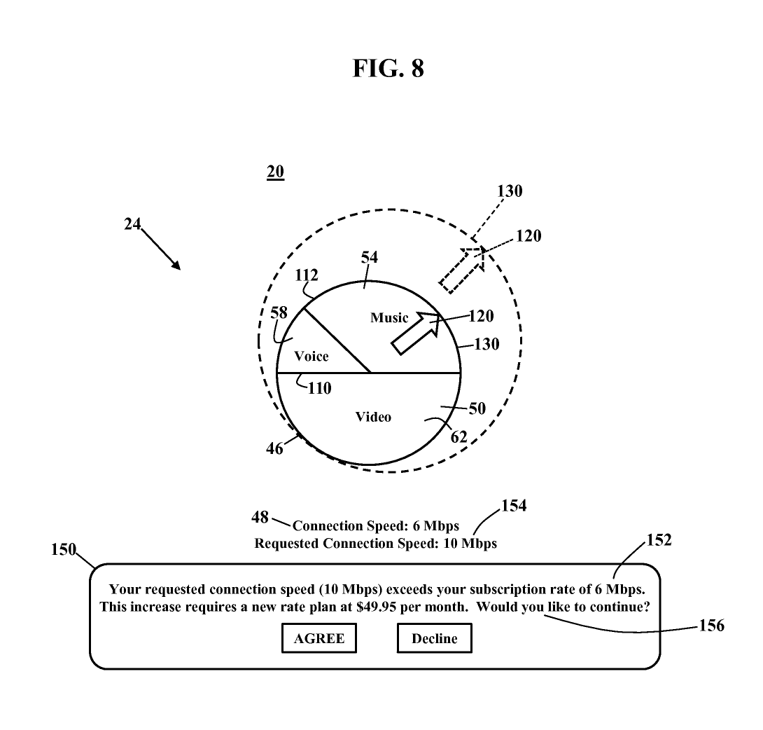

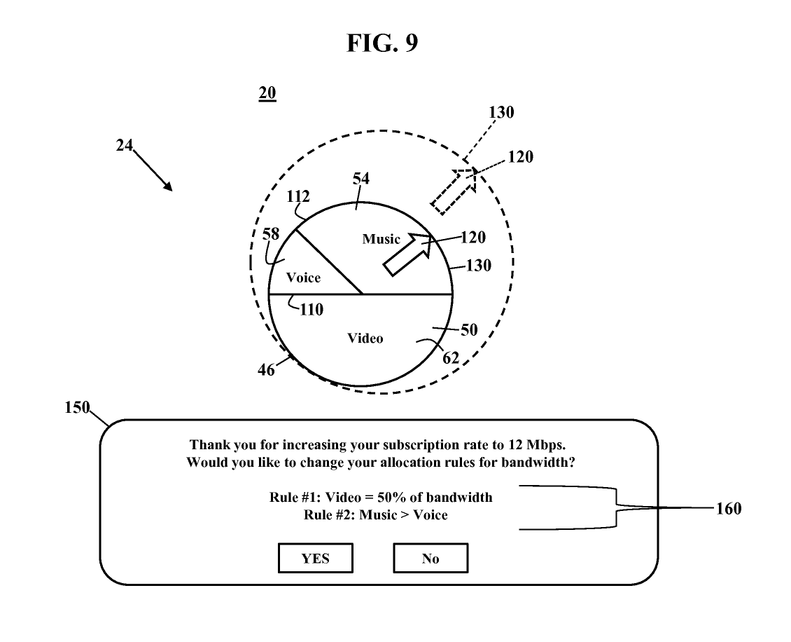

FIGS. 8-9 are schematics illustrating notifications, according to exemplary embodiments. When the user makes changes to the values of the configuration parameters 102, the client-side quality application (illustrated as reference numeral 86 in FIGS. 2-3) may generate, or receive, a notification 150 regarding those changes. The user's desired changes, for example, may not be feasible, so the client-side quality application 86 may deny the user's desired changes. For example, the user's desired allotments may lie outside permissible ranges of values, so the notification 150 may deny the requested allotment. The user's desired configuration parameters 102 (such as bandwidth, packet loss, jitter, and/or latency) may exceed a maximum value (such as a monthly data limit or rate limit), so the notification 150 may inform the user of an increased rate plan. If the user requests 20 Mbps, but this request exceeds what is technically feasible, then client-side quality application 86 may restrict the user from requesting excessive bandwidth. The client-side quality application 86 may thus have intelligence to deny changes that exceed maximum threshold values.

FIG. 8, for simplicity, again illustrates the total amount 48 of bandwidth consumed by the user device 28. If the user enlarges the diameter 110 and/or the circumference 112 of the pie chart 46 (to increase bandwidth), the desired increase may exceed the user's monthly subscription rate 152. Suppose the user only subscribes to six megabits per second (6 Mbps) of downstream data, but the user enlarges the pie chart 46 to request ten megabits per second (10 Mbps). The client-side quality application 86 and the server-side quality application 92 may compare the requested configuration parameters 102 to the user's monthly subscription rate 152 and determine an overage or excessive bandwidth 154 is requested. The client-side quality application 86 may cause the graphical user interface 20 to display the notification 150, and the notification 150 informs the user of excessive bandwidth 154. The notification 150 may even prompt the user to accept a higher rate plan that permits ten megabits per second (10 Mbps).

As FIG. 8 illustrates, the notification 150 may inform the user of billing and/or service modifications. When the user increases the size of the pie chart 46, the notification 150 may display a financial impact 156 of the requested change. The client-side quality application 86 may even query a profile and compare the user's friend's configuration parameters 102. The client-side quality application 86 may even make suggestions to improve the user's quality of service and/or quality of experience (e.g., suggested configuration parameters 102 to improve video transmission or call quality). As users makes changes to their configuration parameters 102, the notification 150 may inform a user of the costs and/or rates 156 that will be incurred, along with competitive comparisons. Exemplary embodiments thus allow users to directly see the impacts of changes to their configuration parameters 102.

FIG. 9 illustrates rules 160. The user may establish the rules 160 to implement service preferences. The user may specify that certain applications or services have priority or preference over others. The user, for example, may establish a rule 160 that the video slice 62 must be at least 50% of the available bandwidth, in order to always preserve the proportional bandwidth 100 for movies and other videos. Another rule may specify that slice N₁ should never be more that 20% greater than slice N₂, where N in an integer value corresponding to different slices 50. If the end user's bandwidth is considered as a “pie” of a particular size, the slices 50 may be thought of as the “pieces” of that pie. So, not only may the user control the pieces of the pie (e.g., setting the sizes of the slices 50), but exemplary embodiments allow the user to select policy/preference rules 160 that may control relationships and relative amounts.

Features may also be activated. As the user controls their quality of service and experience, the user may also activate associated features or aspects/settings that incur additional charges. Such charges are clearly indicated (such as by the notification 150) to permit the user to make informed decisions. Exemplary embodiments may thus require that customer platforms report changes in their services/applications, especially when those services/applications are not offered by the same service provider of the feature. For example, in the 3GPP Long Term Evolution (LTE) standard for mobile network technology, a report that is generated by the user equipment (without user involvement) called Channel Quality Indicator (or CQI). The Channel Quality Indicator report is derived from the downlink received signal quality, typically based on measurements of the downlink reference signal.

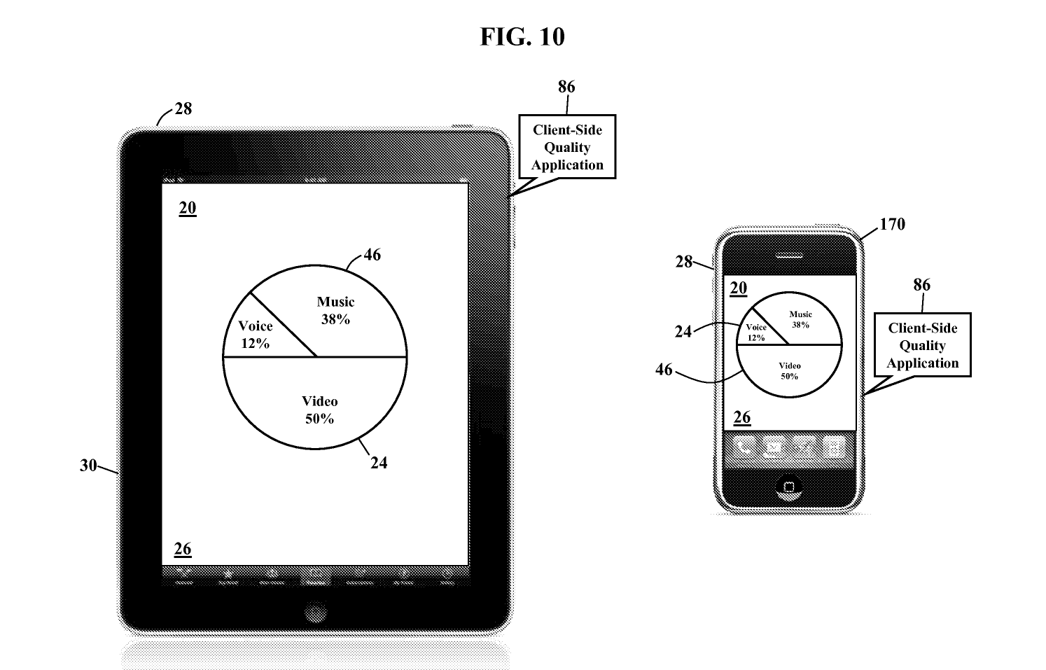

FIG. 10 is a schematic illustrating similarity of controls, according to exemplary embodiments. FIG. 10 illustrates the graphical user interface 20 produced on different user devices 28. Even though the graphical user interface 20 (and the icons 24) may be displayed on both the tablet computer 30 and on a mobile smart phone 170, the graphical user interface 20 has the same look and feel. Even the pie chart 46 may be similarly produced to control the user's quality of service and experience. Regardless of the user device 28 (laptop, desktop, netbook), the graphical user interface 20 may be modified to adjust to different format factors and sizes.

Exemplary embodiments thus permit users to control quality of service and experience. The graphical user interface 20 presents the icons 24 as a meter of the network performance measurements received from, or provided by, the communications network (illustrated, respectively, as reference numerals 40 and 22 in FIG. 1). The icons 24 may also be selectable to implement changes to quality and service. Exemplary embodiments thus permit users to control the experience of their communications services. The icons 24 may indicate the current quality of service and experience that the user is currently getting and may be service/application specific.

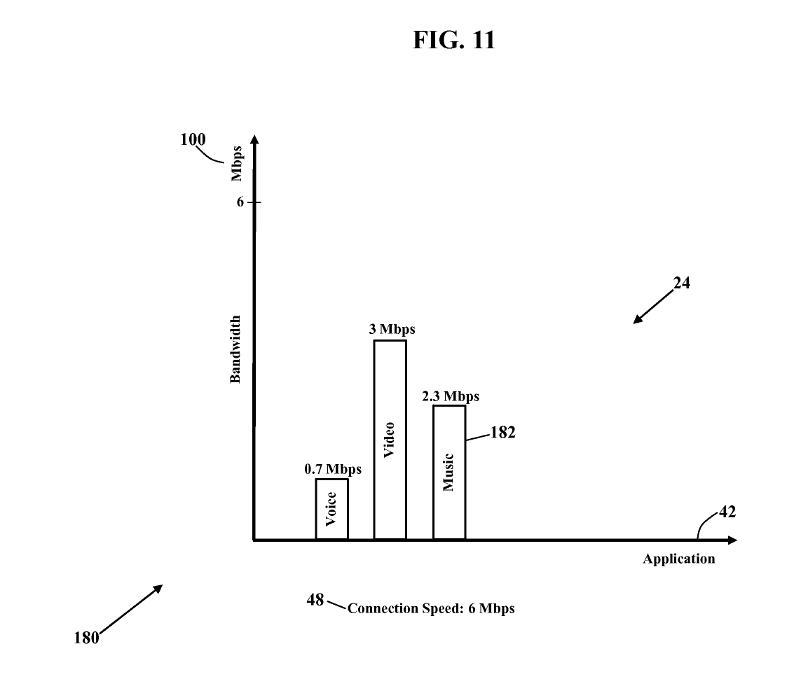

FIGS. 11-14 are schematics illustrating different icons 24, according to exemplary embodiments. As the above paragraphs explained, the pie chart 46 is only one example of visually illustrating the quality and performance received from the communications network 22. The graphical user interface 20 may utilize any graphical representation that conveys the network performance measurements 40 received from, or provided by, the communications network 22. The graphical user interface 20 may, likewise, utilize any graphical controls that permit users to control the quality and experience of their communications services. The user may even mix and match different shapes and/or graphical controls to achieve the user's preferred look and feel.

FIG. 11, for example, illustrates different icons 24 for indicating quality of service and experience. FIG. 11 illustrates a bar chart 180 that indicates the bandwidth 100 consumed by each software application 42. Each service/application 24 is represented by a corresponding graphical bar 182. The height of the graphical bar 182 represents the bandwidth 100 consumed by the corresponding software application 42. The total amount 48 of available bandwidth may be indicated, and the proportional amount 52 consumed by each software application 42 is visually indicated by comparing the heights of different bars 182.

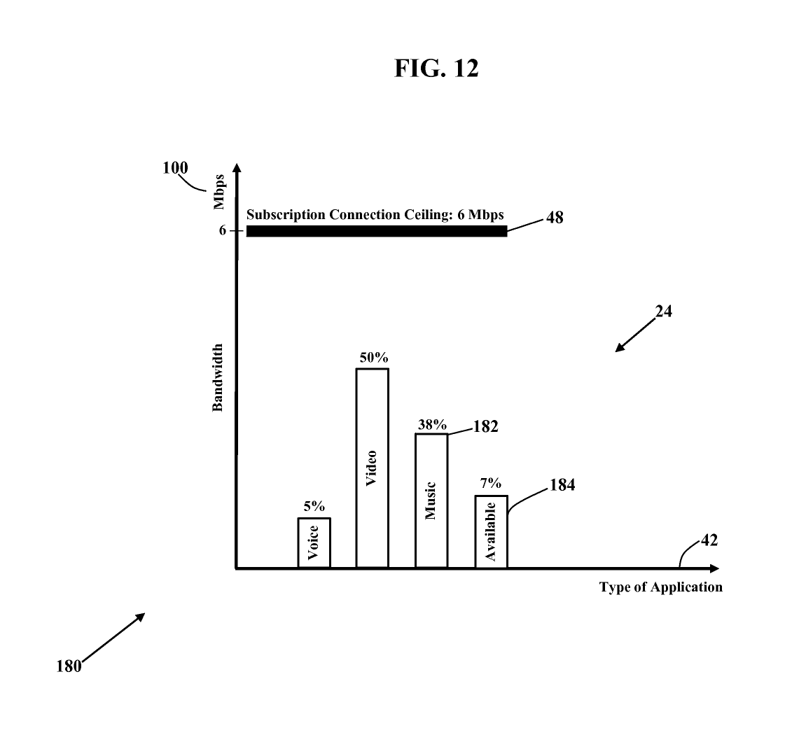

FIG. 12 is similar to FIG. 11, yet here the proportional amount 52 is mathematically described as percentages. The total amount 48 of bandwidth is represented as 100%, and the bandwidth consumed by each software application 42 is proportionally described. If any bandwidth 100 is unused, the graphical user interface 20 may illustrate unused bandwidth 184 as a percentage or numerical rate. While FIG. 12 illustrates types of software applications, each individual software application (illustrated as reference numeral 24 in FIG. 1) may be graphically illustrated. As earlier paragraphs explained, exemplary embodiments may visually illustrate any or all software applications 42 resident on the user device 28. Even if a software application 42 is not open or running, the icon 24 may still illustrate minimized, closed, or not running software applications 42. Exemplary embodiments may thus illustrate individual applications.

FIG. 12 may also illustrate memory consumption. Because the icon 24 may illustrate all software applications 42 resident on the user device 28, a width of the graphical bar 182 may be proportional to the amount of memory used by the corresponding software application 42. Greater memory consumption would thus have a greater width of the graphical bar 182, while less memory consumption would have a smaller width.

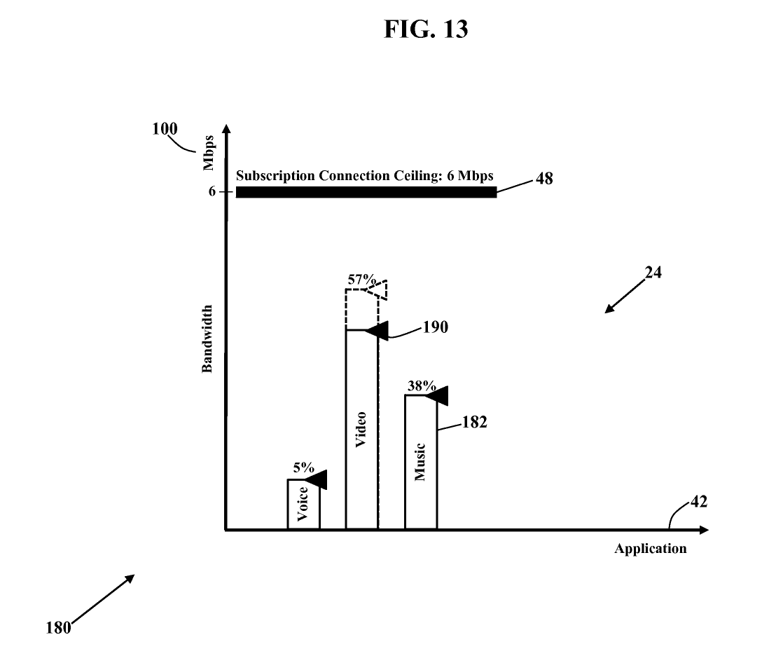

FIG. 13 illustrates graphical controls. Here the graphical bar 182 may also have a graphical slider control 190 that permits the user to change the bandwidth 100 allocated to an individual or group of service/applications. Moving or sliding the graphical slider control 190 changes the bandwidth 100 allocated to the corresponding application(s). The user upwardly drags the graphical slider control 190 (such as by selecting and dragging) to increase bandwidth. Moving the graphical slider control 190 downward reduces the bandwidth. FIG. 13 thus illustrates graphically increasing the bandwidth 100 allocated to the video applications, so any bandwidth allocated to HULU® and/or YOU TUBE® would be increased.

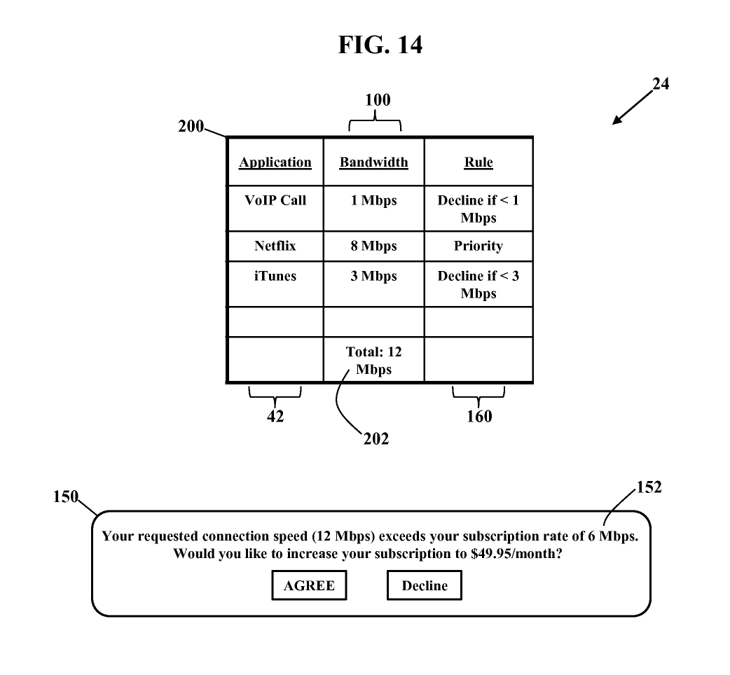

FIG. 14 illustrates numerical entry. Here the icons 24 may be structured as a table 200 that displays the applications 42 and their corresponding bandwidth 100. Each application 42 receiving communications services from the communications network 22 is listed in the table 200. The table 200 may even list applications 42 that are installed on the user device 28, yet not open or running to receive communications services. Regardless, the user may populate the table 200 with the bandwidth 100 allocated to each specific service/application. The user thus enters mathematical values (e.g., percentages and/or rates in bits per second) for the bandwidth 100 desired for each service/application. The table 200 may even have a field 202 that is programmed to automatically sum or total the user's allocations. The client-side quality application 86 and/or the server-side quality application 92 may then perform a check and compare the entered values to the user's service agreement or monthly rate plan 152. The notification 150 may alert the user when excessive bandwidth is requested, and the user may be prompted to accept a higher rate plan. The sum or total (e.g., field 202) of the user's allocations may be less than 100% to implement a bandwidth “cushion,” for whatever reason.

FIG. 14 also illustrates the rules 160. The table 200 may also have data fields that accept entry of the rules 160 for maintaining service preferences. The user, as before, may specify that certain applications or services have priority or preference over others. The table 200 may thus be another simple and easily understood icon 24 for allocating bandwidth 100 to the user's applications 42. The table 200, though, requires more mathematical skill, so the pie chart (illustrated as reference numeral 46 in FIGS. 1 and 3-10) or any other graphical representation may still be preferred.

FIGS. 11-14 thus illustrate that any type and style of icons 24 are applicable. Any graphical illustration may be used to indicate quality and performance expected from the communications network 22. Any graphical control may be used to change the quality and experience of communications services. Even numerical entry (as FIG. 14 illustrates) may be used to convey the network performance measurements 40 and to change the configuration parameters 102. The pie chart 46, however, currently seems the simplest to understand, and the easiest to manipulate, for most users. Exemplary embodiments, however, may implement any input approach, including interactive windows, pop-ups, checkboxes, and any other graphical representations and controls. Exemplary embodiments may even display and list additional, available services/applications that the user may not be currently using.

The various icons 24 in FIGS. 1 and 3-14 illustrate that the network performance measurements 40 and the configuration parameters 102 may be separate or combined. The icons 24 may display not just quality of service and experience (e.g., status and particulars in varying appropriate detail), but the icons 24 may also be used for control. For example, the user may be allowed to select or “click” the icon 24 and then a menu of current customer services and applications that he/she uses is shown, with current quality of service settings. The graphical user interface 20 may also visually and/or audibly present the kind of changes that are possible for each of these settings, and then allow the user to make changes. Again, though, as the user changes the quality of service for one service, the range of quality of service and experience possibilities for other services and applications may need to change accordingly. A set of specific user data, and perhaps other users' (e.g., friends, neighbors, or user's in the same or similar cellular cell or on the same or similar shared network) data—and network data—may be used to guide these controls, including but not limited to the present user's access network capabilities, device capabilities, etc. If the user subscribes to a faster connection or service, the icons 24 may change in size to visually indicate increased download speeds.

As FIGS. 1 and 3-14 also illustrate, the icons 24 preferably combine meter and control. That is, the icons 24 may convey the network performance measurements 40, and the icons 24 are preferable selectable to change the configuration parameters 102. The icons 24 may thus combine both measurement/display of quality of service and experience to the user, plus the icons 24 allow direct user control of that quality of service and experience.

Exemplary embodiments thus provide a new solution for user control of network configuration. Exemplary embodiments easily convey the services and/or applications being invoked by users. Exemplary embodiments also perform specific service/application level performance measurements for each service/application, with a configurable frequency determined by a service provider, in a cost effective manner. Exemplary embodiments also reflect the outcome of those performance measurements using the icons 24 on the user device 28.

Exemplary embodiments also allow user changes to their quality of service and experience, on a per service/application basis. The user's changes may be saved updates in real-time in the communications network 22. This may result in billing updates, and charges will be presented to the user, as appropriate. Exemplary embodiments may even permit the user to experience, or “test drive,” the desired changes for an evaluation period of time, without charge, or without charging the user until they commit in some fashion to the new settings.

Exemplary embodiments put the user in control of their communications services. Most users will enjoy this control, as long as the control mechanisms provide a simplistic set of features that are easy to understand. Indeed, users have the capability to immediately see whether their purchased services match their expectations and their experiences.

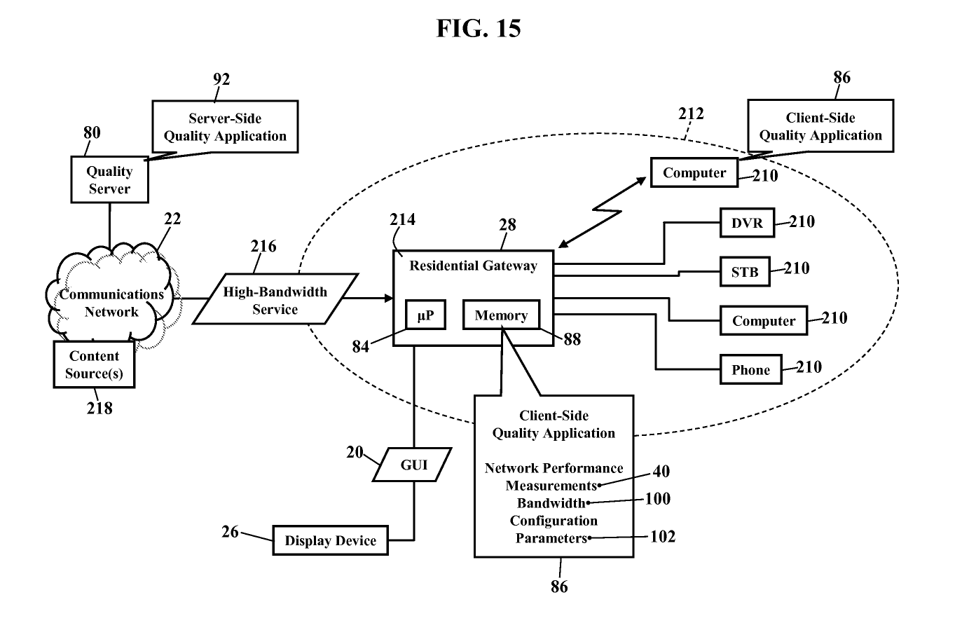

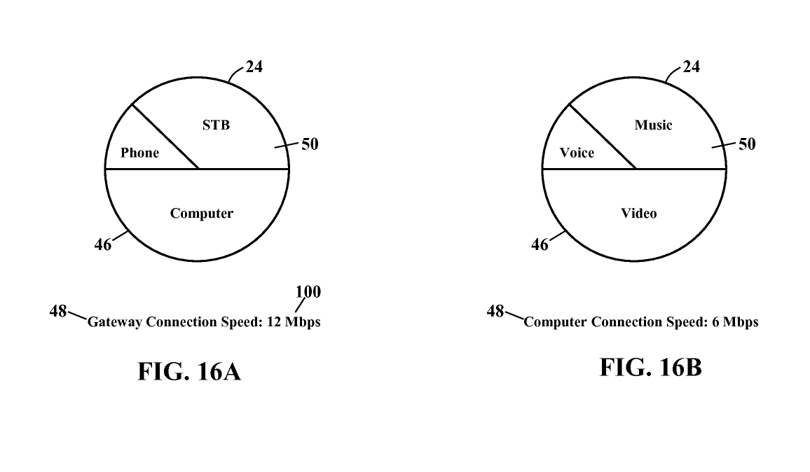

FIGS. 15 and 16 are schematics illustrating a residential networking environment, according to exemplary embodiments. Here, exemplary embodiments may be applied to specific applications/services executing on different devices 210 in a home network 212 (e.g., a home local area network). In FIG. 15, a residential gateway 214 communicates with the home network 212 and with the communications network 22. The residential gateway 214 receives high bandwidth service 216 from one or more content sources 218 in the communications network 22. The residential gateway 214 distributes the high bandwidth service 218 to the various devices 210 in the home network 212. The residential gateway 214, for example, may have one or more interfaces to receive high-bandwidth signals from a digital subscriber line, from a coaxial cable, and/or from a satellite antenna. The residential gateway 214 may additionally or alternatively have interfaces to fiber optic lines, the Home Phone Networking Alliance (“HPNA”), wireless BLUETOOTH® and/or WI-FI® links, or any other medium or link. These interfaces, though, are all well known and need not be discussed.

The residential gateway 214 may communicate with the quality server 80. The residential gateway 22 may have the processor 84 and memory 88, and the processor 84 may execute the client-side quality application 86 stored in the memory 88. The client-side quality application 86 and the server-side quality application 92 again cooperate to evaluate the network performance measurements 40 and to modify the network configuration parameters 102 that are accessible to the residential gateway 22 and/or to the devices 210 in the home network 212.

Here, though, the user allocates the bandwidth 100 and any other network configuration parameters 102 between the applications (illustrated as reference numeral 42 in FIGS. 1-14) executing on the different devices 210 in the home network 212. The client-side quality application 86, executing in the residential gateway 214, may discover and identify the devices 210 physically connected to, and/or wirelessly communicating with, the residential gateway 214. The devices 210 may include one or more modems, set-top boxes, digital video recorders, gaming devices, computers, wireless devices, phones, plug-and-play devices, home automation devices, and security devices and sensors. The client-side quality application 86 may then be used to allocate the communications services received by any device 210 from the communications network 22.

FIG. 16 illustrates allocation of the home network 212, according to exemplary embodiments. Even though the previous paragraphs explained resource allocation of the communication/access loop network with an ISP, exemplary embodiments may be extended to allocations in the user's home network (illustrated as reference numeral 212 in FIG. 15). FIG. 16A thus illustrates device allocations, while FIG. 16B illustrates the allotments within each device. In FIG. 16A, the icon 24 may represent the bandwidth 100 allocated to each device 210 physically connected to, and/or wirelessly communicating with, the residential gateway (illustrated, respectively, as reference numerals 210 and 214 in FIG. 15) in the user's home network 212. Each device 210, in other words, may have a corresponding slice 50 that graphically and proportionally illustrates the bandwidth 100 allocated to each device 210. FIG. 16A, for example, illustrates a computer slice 220 that proportionally illustrates the bandwidth 100 allocated to a computer physically connected to, and/or wirelessly communicating with, the residential gateway 214. A set-top box (“STB”) slice 222 and a phone slice 224, respectively, proportionally illustrate the bandwidth 100 allocated to a set-top box and a phone physically connected to, and/or wirelessly communicating with, the residential gateway 214.

FIG. 16B then illustrates the bandwidth 100 allocated between the applications 24 executing within a device 210. FIG. 16B, for example, illustrates the bandwidth 100 allocated to the applications 24 (e.g., video, music, and voice) allocated within a computer physically connected to, and/or wirelessly communicating with, the residential gateway 214. Each pie chart 46 again conveys the network performance measurements 40 associated with each respective device 210, as the above paragraphs explained. Moreover, the user may select any of the pie charts 46 to modify the configuration parameters 102 associated with each respective device 210, as the above paragraphs also explained. Exemplary embodiments may thus be easily adapted to multiple devices in home networks.

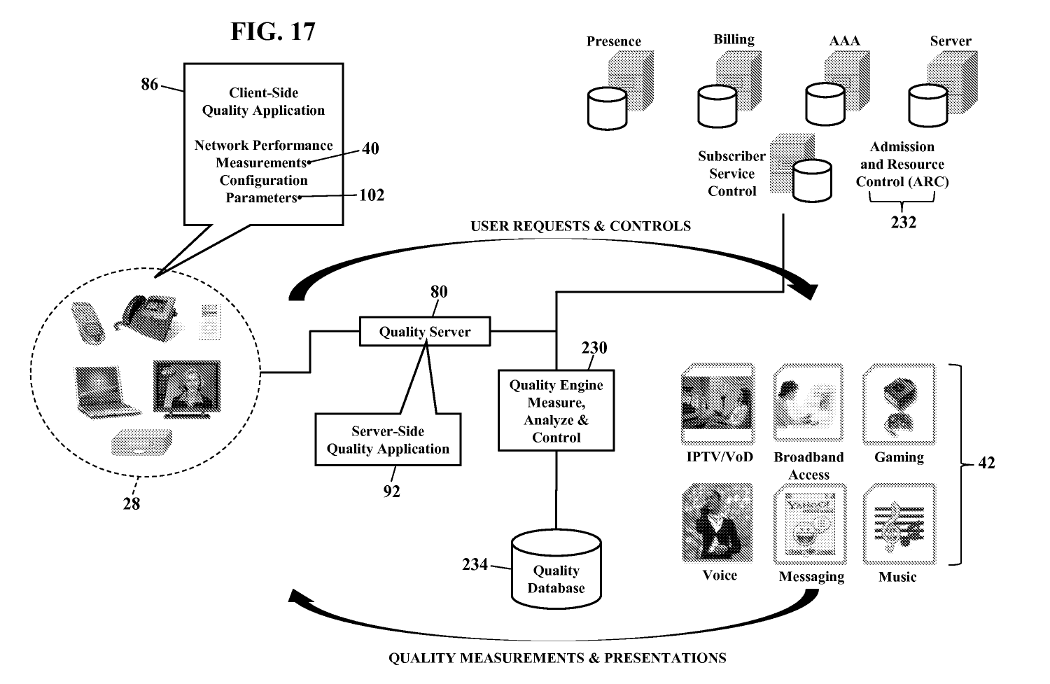

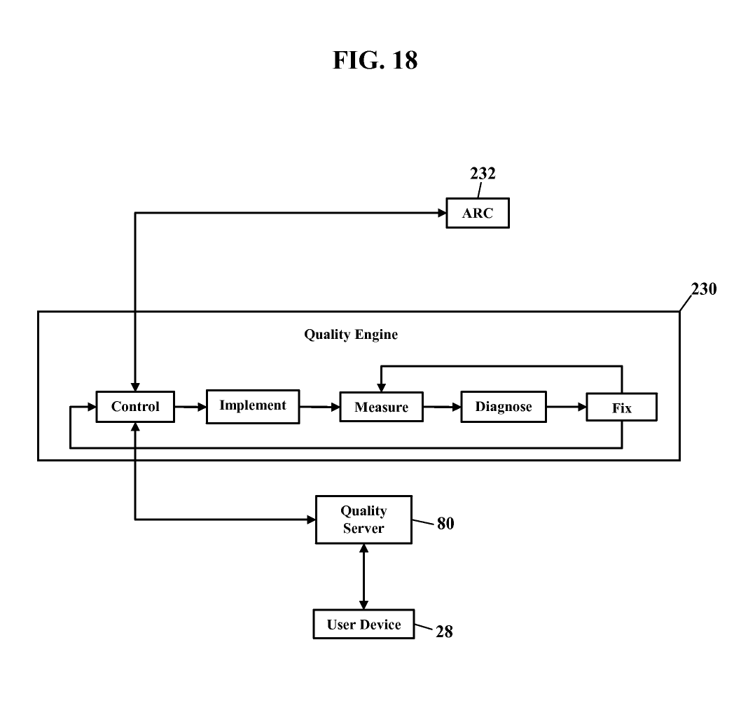

FIGS. 17-18 are more detailed schematics illustrating the operating environment, according to exemplary embodiments. Here again the user device 28 communicates with the quality server 80. The client-side quality application 86 and the server-side quality application 92 cooperate to evaluate the network performance measurements 40 and to modify the network configuration parameters 102 that are accessible to the client user device 28. The server-side quality application 92 contains the capabilities and logic of a quality engine 230 to calculate the quality of service and experience values for each application 42.

The client-side quality application 86 executes in the user device 28. The end user interacts with the client-side quality application 86. The client-side quality application 86 provides the user with consumer control options, the network performance measurements 40, and other key performance indicators. The client-side quality application 86 also provides the control options to the user as determined by the quality server 80. The client-side quality application 86 collects device and consumer data (preferences, performance indicators, etc.) and sends this data to the quality server 80. The client-side quality application 86 also sends reports to the communications network (illustrated as reference numeral 22 in FIG. 2) asynchronously when the user device 28 changes its services/applications set. This reporting feature allows the communications network 22 to know the type of service/application resident on the user device 28 and the dates/times when any application(s) or service(s) is/are being consumed by the user so that only the relevant performance calculations are performed. Various conditions and/or circumstances associated with applications or services may also be reported, such as location and other usage, concurrent or previous.

The client-side quality application 86, however, may be resident in the communications network 22. The client-side quality application 86, for example, may be downloaded to the user device 28 (such as a downloadable “app” for iPads, iPhones, and any other brands of smartphones, tablets, set top boxes, computers, and other devices). The client-side quality application 86 may thus reside in the communications network 22 and share information with the user device 28 by means of interface or API.

The client-side quality application 86 may also interface with a service provider. The client-side quality application 86 may have a programming or module that provides an interface between the service provider and the user device 28. This interface allows the service provider to communicate with the user device 28, share information with the user device 28, and receive customer requests for changes to quality of service and experience.

Admission and Resource Control (ARC) 232 may be used. The client-side quality application 86 and the server-side quality application 92 may communicate in real-time, perhaps optionally with some filtering, with the service provider's infrastructure to proxy with the Admission and Resource Control 232, in order to send user requests for changes to quality of service and experience. The client-side quality application 86 thus shares the results of the Admission and Resource Control 232 back to the user in (near) real-time. Exemplary embodiments thus create, as near real-time as possible, a closed loop to determine as quickly as possible that the user's desires can be fulfilled. However, there should not be a negative user experience in terms of waiting/hanging the control application for the user. Prediction and/or estimation may in some cases be employed to aid this aspect.

The quality server 80 may determine the network performance measurements 40 associated with the client user device 28. The quality server 80 may also determine the types of controls that are shared with users. The quality server 80 may create the configuration parameters 102 and any other set of customer performance indicators. The quality server 80 then shares this data with the client-side quality application 86 for presentation to the user as the customizable, perhaps menu-driven, graphical user interface 20 to determine the configuration parameters 102 on the application-by-application basis. The quality server 80 interacts with the quality engine 230 to generate the necessary reports, and quality server 80 interacts with the service provider infrastructure (e.g., the Admission and Resource Control 232) for control. The reports and results are presented to the user device via the graphical user interface 20.

The client-side quality application 86, however, may also measure and/or verify. As earlier paragraphs explained, the client-side quality application 86 may evaluate and verify any performance measurements. The client-side quality application 86 measures and evaluates any inputs from the user (at the user device 28) to ensure the inputs are valid and attainable. The client-side quality application 86 at least measures a common set of performance/quality metrics such as loss, delay, jitter, etc. The client-side quality application 86 and the server-side quality application 92 may cooperate to develop and evaluate what metrics the user device 28 is capable of measuring. Some user devices 28 may be more sophisticated than others and measure metrics other devices may not measure.

The quality server 80 may reside in the service provider's network. The quality server 80, for example, may be implemented at any physical or logical position, such as at a broadband network gateway or a public gateway to a public network. These particular locations may be a convenient location where interaction with the network Admission and Resource Control 232 is possible and cost effective).

The quality engine 230 ensures quality of service and experience. The quality engine 230 provides all the capabilities and logic to provide the user with the requested configuration parameters 102 and any other sets of customer performance indicators. The quality engine 230 also provides reports and other network information, such as any calculations necessary to compute the quality of service and experience for the service/application for the user.

The quality engine 230 interacts with network infrastructure. The quality engine 230, for example, interacts with a policy infrastructure or functionality in real-time (such as the Admission and Resource Control 232) for checking and/or enforcing user modifications to the configuration parameters 102. The quality engine 230 may also determine additional resource availability (in case a control request is being addressed). This may be done using policy rules, static rules, algorithms, thresholds, multiple result combining methods, and other enforcement mechanisms. The quality engine 230 interacts as needed to achieve the implementation of the user-requested quality of service and changes.

The quality engine 230 may indirectly interface with the client-side quality application 86. The quality engine 230 may be implemented at any physical or logical position, such as at a broadband network gateway or a public gateway to a public network. These particular locations may be a convenient location where interaction with the network Admission and Resource Control 232 is possible and cost effective).

A quality database 234 may provide a storage function. The quality database 234 stores information related to end user quality settings, preferences, relevant policy rules, and any other data. The quality database 234 may be separate from other databases used by the service provider's network, or the quality database 234 may be a part of another database, or the quality database 234 may be spread across a number of other databases.

Exemplary embodiments may advantageously use the Admission and Resource Control 232. As those of ordinary skill in the art understand, the Admission and Resource Control 232 provides a set of capabilities that can be used, by the user at the user device 28, to understand the impact of the service provider's investment and how that investment changes the user's experience. Dynamic actions are more visible to the end user, for the service provider's actions and upgrades are not visible to the user unless put into usage in a dynamic fashion to enhance the user experience. The Admission and Resource Control 232 may thus be exploited across the wired and wireless networks to reveal the service provider's investment in service enhancements.

As the above paragraphs explained, the service provider may make any capability accessible to the end user. Exemplary embodiments, for example, may permit the user to access and/or change the bandwidth 100, latency, packet loss, and jitter. Other capabilities include changing profiles to provide advantageous customer charging, changing entitlements and rules, and providing detection and control of usage based on time of day and congestion situations. Still more capabilities include steering applications to more favorable tiering situations, providing comparative studies on the service bundles, providing trial passes and preventing situations that result billing shocks” and disgruntled customers.

The Admission and Resource Control 232 may thus be advantageously used. The Admission and Resource Control 232 may interact with wired and wireless networks at the same time. However, the Admission and Resource Control 232 provides these enhancements by design by providing the enhancements to admission control, end-user/endpoint configuration, dynamic resource allocation, forwarding topology, and locating endpoints.

The Admission and Resource Control 232 may thus implement the user's choices. When the user wishes to change their quality of service and/or experience, the user's choices may be submitted to the communications network 22 and directly submitted to an ARC function to try to accomplish the user choices in real-time. If for any reason the Admission and Resource Control 232 runs into trouble to implement the user's choices, an error code may be returned, that is understandable for the user, or potentially be automatically linked into other business processes, such as a customer help desk, depending on the purchased service. It is also possible that the Admission and Resource Control 232 could try a different configuration parameter 102 that still reflects closely what the user desired. The Admission and Resource Control 232 may even suggest different configuration parameters 102 to the end user at the user device 28, so that there is some interactivity with the user.

The quality engine 230 may drive alternative suggestions. When the end user requests a change to their quality of service and experience, the quality engine 230 may determine a best alternative action by interacting with the Admission and Resource Control 232. The quality engine 230 may utilize an iterative process, possibly aided by policy (e.g., relevant policy rules could be utilized for aspects of decision making in the quality engine 230). The quality engine 230 may make successive submissions (within a configurable limit number, or do-not-exceed time period) to determine the best alternative action. The quality engine 230 may also notify the end user (via the notification 150) of a possible upgrade that could allow the user to obtain their desired changes, with an optional free preview and/or trial period (as earlier paragraphs explained). The quality engine 230 may also notify of changes that improve the user's quality and experience.

Exemplary embodiments thus provide both meter and control. Exemplary embodiments simply convey the services and/or applications being invoked by users and performance measurements for each service/application. Exemplary embodiments also allow user changes to their quality of service and experience, on a per service/application basis. Exemplary embodiments may thus interactively combine verification and control using easily understood and selectable graphical icons 24.

Verification is predicted to be popular with end users. Today end users, especially residential customers, normally do not know whether the (key or otherwise) parameters they are promised are met by their service provider. A user with “promised” download speeds of 1 Mbps might actually be getting 500 Kbps. Verification enables the user to trust the service provider, increasing the likelihood that the user will pay for an additional, upgraded, or higher quality of service.

Control will also be popular with end users. Once the end user sees and verifies the key quality of service and experience aspects that matter to them, per application or service, the user will gain from an ability to alter the mix of “quality” across all the services that are part of their overall services. For instance, the end user often needs to maximize or optimize what they are getting (for a particular cost), and exemplary embodiments permit changes to quality of service and experience. The end user, for example, may trade-off gaming or surfing “quality” for increased video “quality,” when desired.

Exemplary embodiments also benefit service providers. Service providers may realize significant potential revenue opportunities, such as new revenues from potential charges from customers who are willing to pay for additional awareness of and control over quality of service and experience. Service providers may also realize additional revenue opportunities from reduced churn provided by increased customer satisfaction. Exemplary embodiments may be widely adopted, due to customer desires for more control over their service and experience. Moreover, because video service has exploded and stressed most networks, and continues to increase and further stress networks, customers will pay for measureable and changeable quality of service.

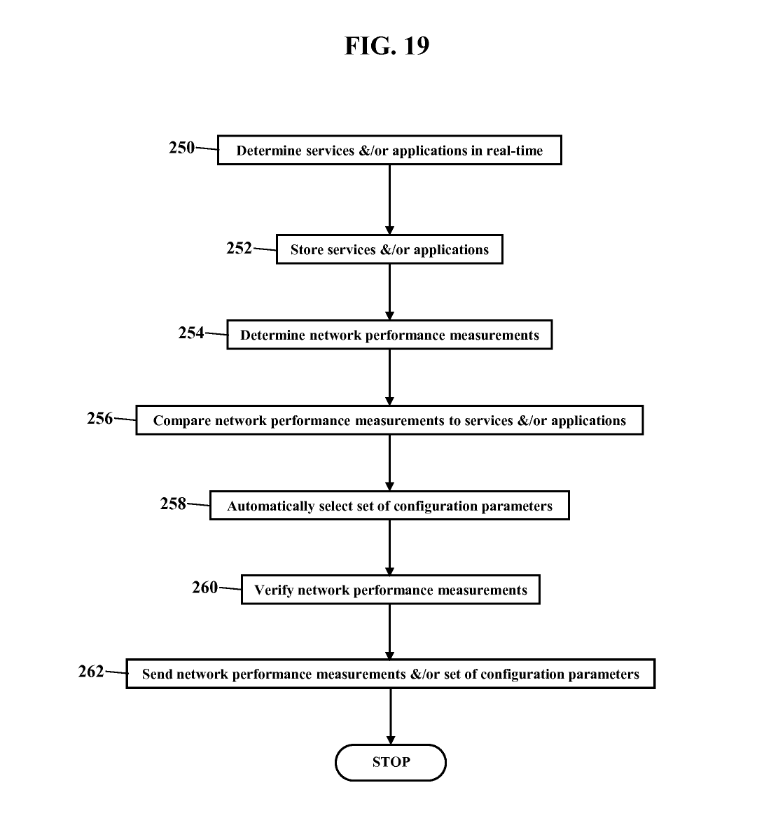

FIG. 19 is a flow chart illustrating a method for control of quality of service, according to exemplary embodiments. FIG. 19 illustrates an automated process that automatically implements best performance measurements. Services and/or applications, utilized by the user device 28, are determined in real-time (Block 250). If the services and/or applications are provisioned in the service provider's network, then exemplary embodiments may query a provisioning system. Exemplary embodiments, however, may additionally or alternatively query the user device 28 for the services and/or applications, and the user device 28 may support asynchronous updates. Regardless, the services and/or applications are stored (Block 252). The network performance measurements 40 are determined (Block 254) and compared to the services and/or applications (Block 256). A set of configuration parameters 102 (such as the Admission and Resource Control 232 parameters) may then be automatically chosen (Block 258) using rules, policies, and algorithms. The network performance measurements 40 may be periodically or randomly verified (Block 260) to ensure compliance. The network performance measurements 40 and/or the set of configuration parameters 102 may be sent to the user device 28 (Block 262) as the graphical user interface 20 having the icons 24.

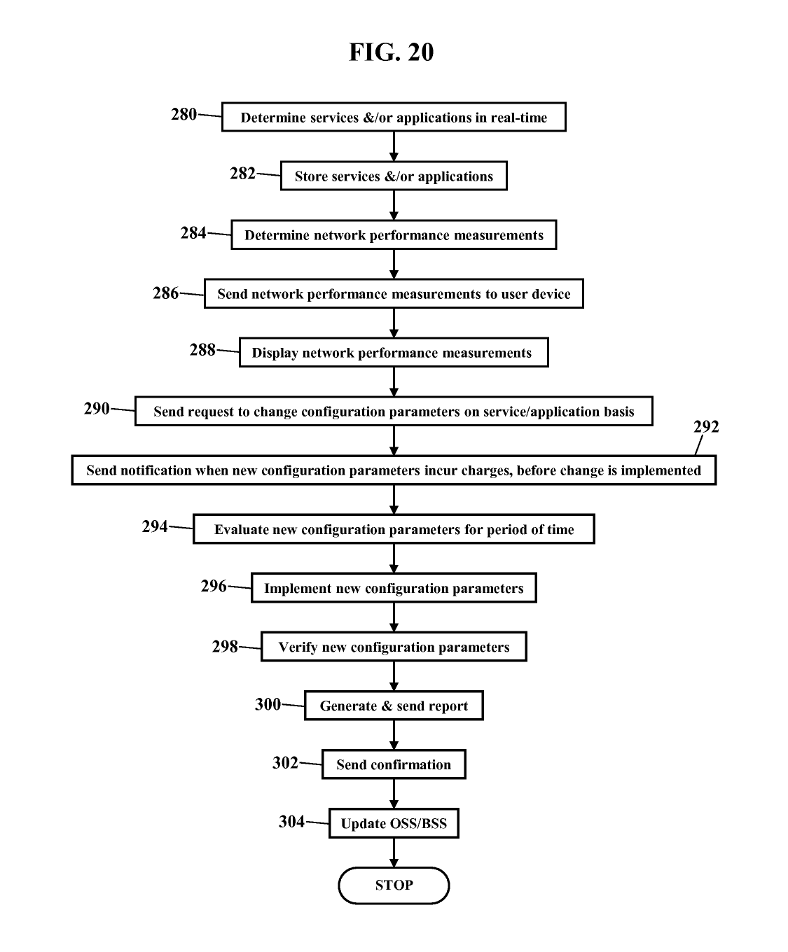

FIG. 20 is another flow chart further illustrating the method for control of quality of service, according to exemplary embodiments. FIG. 20 also illustrates an automated process, but here the end user may manually control the quality of service and experience. Services and/or applications, utilized by the user device 28, are determined in real-time (Block 280) and stored (Block 282). The network performance measurements 40 are determined (Block 284) and sent to the end user device 28 (Block 286). The network performance measurements 40 are displayed at the user device 28 (Block 288) as the graphical user interface 20 having the icons 24. The end user device 28 sends a request to change the configuration parameters 102 (such as the Admission and Resource Control 232 parameters) on a service or application basis (Block 290). The notification 150 is sent when new configuration parameters would incur charges, before the change is implemented (Block 292). The user may evaluate the new configuration parameters, for a period of time (Block 294). Any evaluation period of time may be chosen or configured by the end user, but the evaluation period of time is preferably established by the service provider. The new configuration parameters are implemented, or pushed, directly into the communications network 22 (Block 296). The new configuration parameters may be verified (Block 298). A report may be generated and sent to the user device (Block 300) when the new configuration parameters fail verification. When the new configuration parameters are verified, confirmation of the change is sent to the user device 28 (Block 302). The confirmation may be sent over a secure channel. Any backend OSS/BSS systems are updated (Block 304).

As earlier paragraphs explained, the icon 24 (or any part of the icon 24) may blink, change color, or otherwise indicate the change is being attempted. When the communications network 22 verifies the user's change can be made (e.g., sufficient capacity is available), and then implements the change, the icon 24 may can change (e.g., solid or green color), indicating the change is complete. Other feedback mechanisms may be provided, thus simplifying everything to the user so that interactions are as intuitive/simple as possible.

Exemplary embodiments may be applied regardless of networking environment. The communications network 22 may be a cable network operating in the radio-frequency domain and/or the Internet Protocol (IP) domain. The communications network 22, however, may also include a distributed computing network, such as the Internet (sometimes alternatively known as the “World Wide Web”), an intranet, a local-area network (LAN), and/or a wide-area network (WAN). The communications network 22 may include coaxial cables, copper wires, fiber optic lines, and/or hybrid-coaxial lines. The communications network 22 may even include wireless portions utilizing any portion of the electromagnetic spectrum and any signaling standard (such as the IEEE 802 family of standards, GSM/CDMA/TDMA or any cellular standard, and/or the ISM band). The communications network 22 may even include powerline portions, in which signals are communicated via electrical wiring. The concepts described herein may be applied to any wireless/wireline communications network, regardless of physical componentry, physical configuration, or communications standard(s).

Exemplary embodiments may be physically embodied on or in a computer-readable storage medium. This computer-readable medium may include CD-ROM, DVD, tape, cassette, floppy disk, memory card, and large-capacity disks. This computer-readable medium, or media, could be distributed to end-subscribers, licensees, and assignees. A computer program product comprises processor-executable instructions for controlling quality of service and experience in the communications network 22, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A system, comprising:
a processor executing code stored in memory that causes the processor to:
receive network performance measurements describing applications utilizing communications services from a communication network;
display the network performance measurements in a graphical user interface;
receive a selection of an icon in the graphical user interface; and
display the network performance measurements that are consumed by each application utilizing at least one of the communications services from the network.

2. The system according to claim 1, further comprising code that causes the processor to display a total amount of bandwidth being consumed by the applications.

3. The system according to claim 1, further comprising code that causes the processor to display an amount of bandwidth being consumed by each application in the applications.

4. The system according to claim 1, further comprising code that causes the processor to display a total amount of bandwidth being consumed by the applications and a proportional amount of the total amount of bandwidth being consumed by each application in the applications.

5. The system according to claim 4, further comprising code that causes the processor to receive selection of a control in the graphical user interface that adjusts the proportional amount of the total amount of bandwidth being consumed by an application in the applications.

6. The system according to claim 4, further comprising code that causes the processor to display the proportional amount of the total amount of bandwidth being consumed by each application in the applications.

7. The system according to claim 1, further comprising code that causes the processor to display network performance enhancements that are available to each application in the applications.

8. The system according to claim 1, further comprising code that causes the processor to display bandwidth enhancements that are available to each application in the applications.

9. A method, comprising:
receiving a total amount of bandwidth being consumed by multiple applications operating in a user device that utilizes communications services from a communications network;
displaying in a graphical user interface at the user device a proportional amount of the total amount of bandwidth being consumed by each application in the multiple applications;
receiving a request to change the proportional amount of the total amount of bandwidth being consumed by an application in the multiple applications; and
updating the graphical user interface to reflect revised proportional amounts of the total amount of bandwidth being consumed by each application in the multiple applications.

10. The method according to claim 9, further comprising receiving another request to change a quality of service associated with the application in the multiple applications.

11. The method according to claim 9, further comprising generating a cost to a user to change the proportional amount of the total amount of bandwidth being consumed by the application.

12. The method according to claim 9, further comprising evaluating a requested change to the proportional amount of the total amount of bandwidth being consumed by the application.

13. The method according to claim 9, further comprising verifying that the proportional amount of the total amount of bandwidth was changed.

14. The method according to claim 9, further comprising displaying feedback in the graphical user interface that confirms the proportional amount of the total amount of bandwidth was changed.

15. The method according to claim 9, further comprising displaying constraints that limit changes to the proportional amount of the total amount of bandwidth.

16. The method according to claim 9, further comprising ensuring the proportional amount of the total amount of bandwidth is less than the total amount of bandwidth.

17. A computer readable medium storing processor executable instructions for performing a method, the method comprising:
receiving a total amount of bandwidth being consumed by multiple applications operating in a user device that utilizes communications services from a communications network;
displaying the total amount of bandwidth as an icon in a graphical user interface produced by the user device;
receiving a selection of the icon;
displaying in the graphical user interface a proportional amount of the total amount of bandwidth being consumed by each application in the multiple applications;
receiving a request to change the proportional amount of the total amount of bandwidth being consumed by an application in the multiple applications; and
updating the icon to reflect revised proportional amounts of the total amount of bandwidth being consumed by each application in the multiple applications.

18. The computer readable medium according to claim 17, further comprising instructions for displaying the icon as a pie chart in the graphical user interface, wherein a total area of the pie chart represents the total amount of bandwidth being consumed by multiple applications.

19. The computer readable medium according to claim 17, further comprising instructions for displaying the proportional amount of the total amount of bandwidth being consumed by the application as a slice of the pie chart.

20. The computer readable medium according to claim 17, further comprising instructions for altering a slice of the pie to represent the request to change the proportional amount of the total amount of bandwidth being consumed by the application.
